(19) United States
(12) Patent Application Publication
(10) Pub. No.: US 2006/0093518 A1
(43) Pub. Date: May 4, 2006

(54) Device containing non-covalently bound biomolecules on solid support

(76) Inventors: Ashok Kumar Shukla, Ellicott City, MD (US); Mukta Misra Shukla, Ellicott City, MD (US)

Correspondence Address: ASHOK K. SHUKLA, 10316 KINGSWAY COURT, ELLICOTT CITY, MD, 21042, US

(21) Appl. No.: 11/259,777

(22) Filed: Oct. 27, 2005

Related U.S. Application Data
(60) Provisional application No. 60/623,109, filed on Oct. 29, 2004.

(51) Int. Cl. G01N 31/22

(52) U.S. Cl. 422/59; 422/101

(57) ABSTRACT

The present invention relates to a novel device for transport of chemicals and biochemicals in small amounts such as in microgram range. For example, a pipette tip, or a film containing chromatographic media, wherein the media contains an enzyme for the enzymic action. The enzyme is adsorbed on the surface of the chromatographic media and is non-covalently bound. These enzyme containing tips will be used for the transport of very small amounts of enzyme to the sample, where the biochemical reaction takes place. They will also be used in a buffer where the enzyme will be kept adsorbed on the chromatographic media and will not dissociate from chromatographic media and the substrate will react with the enzyme on the surface of the media. Furthermore, the presence of chromatographic media can be used simultaneously for the purification of the reaction product from the buffer components.

This application was filed earlier as a provisional Application No. 60/623,109 filed on Oct. 28, 2004. We would like to claim the priority date Oct. 28, 2004.

### FIELD OF THE INVENTION

The present invention relates to a novel device for transport of chemicals and biochemicals in small amounts such as in microgram range. For example, a pipette tip containing chromatographic media, wherein the media contains an enzyme for the enzymic action. The enzyme is adsorbed on the surface of the chromatographic media and is non-covalently bound. These enzyme containing tips will be used for the transport of very small amounts of enzyme to the sample, where the biochemical reaction takes place. They will also be used in a buffer where the enzyme will be kept adsorbed on the chromatographic media and will not dissociate from chromatographic media and the substrate will react with the enzyme on the surface of the media. Furthermore, the presence of chromatographic media can be used simultaneously for the purification of the reaction product from the buffer components.

### BACKGROUND OF THE INVENTION

The enzymic reaction is the most common biochemical reaction in the living organisms. The enzymatic action is used for the identification of biomolecules, for example, the action of proteases on proteins to get their smaller fragments such as peptides and analysis of these fragments by HPLC or mass spectrometry (such as MALDI).

For example in blood serum, 25 proteins make up 90% of the weight of proteins and remaining millions of proteins are present in trace amount. The structural determination of such trace proteins is a great challenge due to:
Their very low concentration in Pico and lower mole ranges.
These molecules are lost at the surface of the container, in which they are purified.
During transfer from one container to the other and during the purification process and enzymic reactions.

Considering above challenges, here we describe a novel device which can overcome such problems. A micropipette tip containing solid particles such as polymer (synthetic or natural) or chromatographic particles. Such particles may contain one or more biomolecule. These biomolecules are adsorbed on the surface of chromatographic particles (non-covalently bound) only by physical interaction such as hydrophilic, hydrophobic, ion exchange, hydrogen bonding, or combination of such physical interactions. The motivation for adsorbing the biomolecule is that it can be adsorbed under one solvent condition and can be eluted from the solid particles into the solution by changing the property of solution.

The advantage of such micropipette tips, which contain chromatographic particles (the particles are fixed in the tips by any means, for example, embedded on the surface of the tip, porous membrane behave as the chromatographic particle, porous membrane with particles, monolithic, or embedded in the polymer and fixed in the tip) is that the substrate (reacting biomolecule) can be catalyzed by enzyme, which is adsorbed on the solid particles. Therefore, after enzymatic action, the product (the biomolecules produced after biochemical action) can be easily separated from the enzyme by dispensing out the solution which contain the substrate and product, for further analysis, by HPLC or Mass spectrometry, electrophoresis or other analytical tools to analyze the biomolecule. This will facilitate further analysis and result in more specific structural analysis.

Furthermore, the solution containing biomolecule is aspirated in a pipette tip with the chromatography material. The solution is left to dry in the pipette-tip thus dispersing the biomolecule on the surface of chromatographic particles. When the pipette-tip is brought into contact again with the solution, the biomolecule will go back into the solution. This helps to transport aliquots of biomolecules in the microgram range. At present the microgram quantities of material is transported in containers. The containers are large in volume and once the biomolecule is dissolved in solution, it is lost partly on the walls of the container. Furthermore, transport from the container to the reaction chamber results in further loss of the biomolecule. Therefore, transport of microgram samples in a tip which contains a specific biomolecule, adsorbed (non-covalently bound) on the surface of a specific chromatographic media, enables minimal sample loss and is easy to handle in microgram range.

This method can be also applied to spots on a film coated with chromatographic material. Furthermore, this technique can be also applied to micro titer plates in different well-formats such as 48, 96, 384, or 1536. The wells can be of certain geometry or have a random distribution. The wells contain chromatographic material at the bottom or on the wall or both.

The various features of novelty, which characterize the invention, are pointed out with particularity in the claims annexed to and forming a part of this disclosure. For a better understanding of the invention, its advantages and objects, reference is made to the accompanying drawings and descriptive matter in which a preferred embodiment of the invention is illustrated.

### BRIEF DESCRIPTION OF THE DRAWINGS

The foregoing and still other objects of this invention will become apparent, along with various advantages and features of novelty residing in the present embodiments, from study of the following drawings, in which:

FIG. 1 is an expanded view of one embodiment of a micropipette tip containing solid particles with non-covalently bond biomolecules for the reaction or transport of biochemicals in small amounts.

FIG. 2 is an expanded view of one embodiment of a tube containing solid particles, with non covalently bound biomolecules for the biochemical reaction or transport of biochemicals in small amounts.

FIG. 3 is an expanded view of one embodiment of tube which can be arranged in multiple well format on a plate.

FIG. 4 is expanded view of one embodiment of film which shows the chromatographic material containing a spot.

### DESCRIPTION OF THE PREFERRED EMBODIMENTS

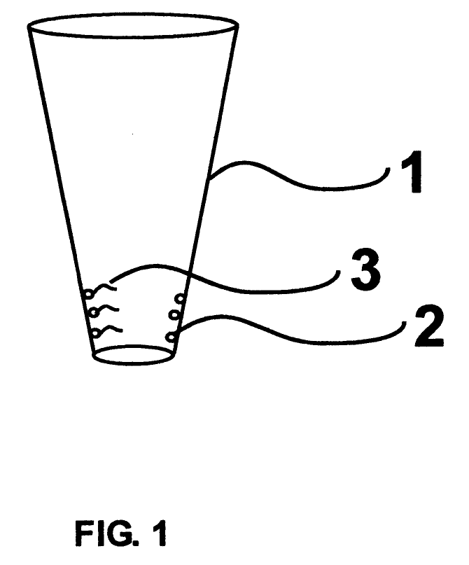

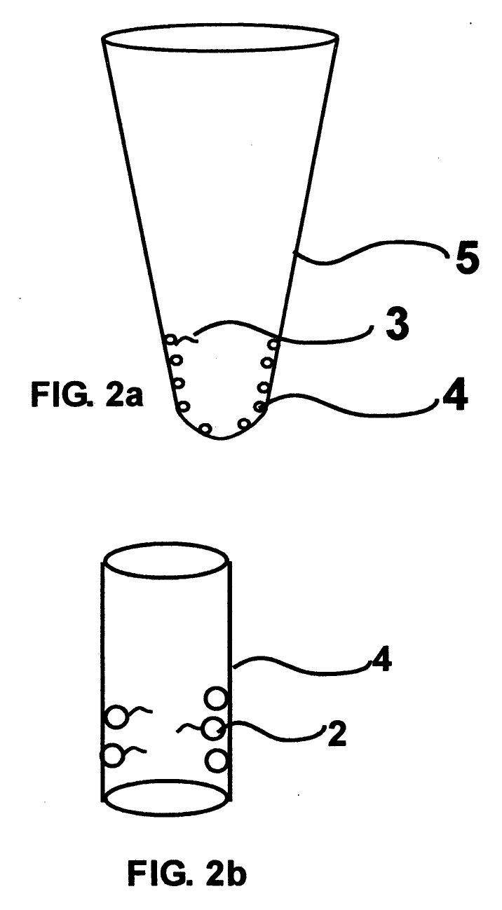

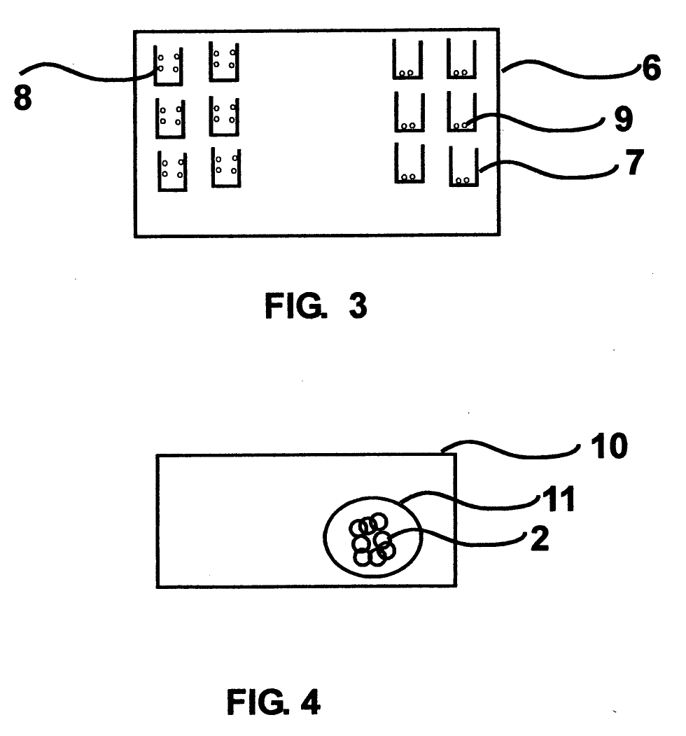

Referring to the drawings, FIG. 1 shows tube open at the both the ends (1), which contain solid particles such as chromatographic material particles (2). Said solid particles (2) contain non covalently bound biomolecule or chemical molecule (3). The Tube (1) can be in the shape of a micropipette tip. The tube (1) can be open at both ends (4) as in FIG. 2a or closed at one end (5) as in FIG. 2b. The tube can be of any length and diameter and can be composed of a combination of one or more different polymer materials from the group consisting of but not limited to, polypropylene, polytetrafluoroethylene, polysulfone, polyethersulfone, cellulose acetate, polystyrene, polystyrene/acrylonitrile copolymer and PVDF. Furthermore, in the FIG. 3, tubes can be arranged in the multiple well format to form a microtiter plate (6) or multi well system. The chromatographic material can be on the wall (8) or at the bottom (9) of well (7) or both bottom and inner wall (10). The micro titer plate format can be 48, 96, 384, or 1536. The wells can be of certain geometry or a random distribution.

In FIG. 4 is shown a spot (11) containing chromatographic material (2) on a film (10). Said solid particles (2) contain non-covalently bound biomolecule or chemical molecule (3). The film can be of any length and spot can be of any diameter or shape. The film (10) is composed of a combination of one or more different polymer materials from the group consisting of but not limited to, polypropylene, PEEK, polytetrafluoroethylene, polysulfone, polyethersulfone, cellulose acetate, polystyrene, polystyrene/acrylonitrile copolymer, PVDF, metal, glass, porous and non porous material, woven or non-woven mesh, woven or non-woven net, and combinations thereof.

The chromatographic material or solid particles (2) can be composed of one or more materials from the group comprised of, but not limited to, silica, non-silica, monolithic, polymer-based, active charcoal, graphite, zirconium, titanium, affinity, immobilized biomolecules or other materials. Said chromatographic material can also consist of other chromatographic media such as gels, bacteria, living cells or solid powder. The chromatographic material particles (2) can be chemically or physically modified and may be porous or non-porous. The sizes of the inert or chromatographic material particles (2) can be from nanometers to millimeters.

The chemical or biochemical molecules (3), which are present on the surface of chromatographic media, can be in native form or chemically or physically modified form. Chromatographic media may contain one or more chemical or biochemical or combination thereof. The biochemical can be protein, DNA RNA, lipids, enzymes, hormones, or any biologically active compound.

The Tube (1), can contain chromatographic media on the inner or outer wall of the tip, or be filled with media. The tube (1) can contain chromatographic media embedded in a polymer. The Tube (1) contains chromatographic media in loose or fixed form. The tube (1) wherein said chromatographic particles are in form of porous membrane or filter disk, can adsorb biomolecules or chemicals.

The, tube (1) or plate (6) or film (10) containing biomolecules, as described in the present invention can be used for different applications including sample preparation for HPLC, HPCE, MALDI and for use in high throughput screening and other analytical methods. The present invention can also be used for diagnostic kits to perform diagnostic tests, for the transport of chemicals or biomolecules and for other applications in research laboratories.

The broader usefulness of the invention may be illustrated by the following example.

### Example #1

### Use of the Present Invention for Protein Digestion in the Micropipette Tip

In this experiment, we used a 1-10 μl micropipette tip containing C-18 chromatographic media on the wall of the pipette tip. 2 ul of trypsin (1 μg/μl) in aqueous solution is aspirated in the pipette tip and dried. 2 μl protein solution such as bovine serum albumin (BSA) solution (1 μg/μl) was aspirated in the tip and left at 37° C. for 1 hour and the BSA-peptide sample was pipetted out and analyzed by HPLC and Mass spectrometry.

### Example #1

### Use of the Present Invention for Transport of Enzyme in a Micropipette Tip

In this experiment, we used a 1-10 μl micropipette tip containing hydrophilic chromatographic media on the wall of the pipette tip. 2 μl of trypsin (1 μg/μl) in aqueous solution is aspirated in the pipette tip and dried. 5 μl of protein digest buffer such as 50 mM ammonium bicarbonate (pH 8.5) was aspirated/expelled (5 times) and then dispensed in a container containing a protein solution (5 μl) such as bovine serum albumin (BSA) solution (1 μg/μl) and was aspirated in the tip and left at 37° C. for an hour and the BSA-peptides sample was analyzed by HPLC and Mass spectrometry.

While a specific embodiment of the invention has been shown and described in detail to illustrate the application of the principles of the invention, it is understood that the invention may be embodied otherwise without departing from such principles and that various modifications, alternate constructions, and equivalents will occur to those skilled in the area given the benefit of this disclosure and the embodiment described herein, as defined by the appended

1. A device consisting of a tube which is open at both the ends and contains solid particles, said particles are fixed in the said tube in such a way that liquid can flow through the said tube, said particles contain non covalently bound adsorbed chemical or biochemical, said chemical or biochemical can be eluted back in the solution for chemical or biochemical reaction by either bringing it into contact with a solution or by changing the properties of the solution.

2. A device consisting of a film which contains solid particles, said particles are fixed on the said film and said particles contain non covalently bound adsorbed chemical or biochemical, said chemical or biochemical can be eluted back in the solution for chemical or biochemical reaction by either bringing it into contact with a solution or by changing the properties of the solution.

3. A device as in claim 1 and 2, wherein, said biomolecule is a biochemical selected from the group comprised of protein, enzyme, lipids, carbohydrates, hormones, glycoconjugates, and combinations thereof.

4. A device as in claim 1, wherein said tube can be closed at one end.

5. A device as in claim 1 and 2, wherein said solid particles is a chromatography material selected from the group comprised of porous chromatography materials; non-porous chromatography materials; silica materials; non-silica materials; monolithic, polymer-based materials; active charcoal; zirconium; titanium; polystyrene; carbon; affinity chromatography materials; immobilized enzyme; polymers; gels; bacteria; living cells; solid powders; porous membrane and combinations thereof.

6. A device as in claim 1 and 2, wherein the particles of said solid medium are chemically, physically or biologically modified.

7. A device as in claim 1 and 2, wherein the particles of said solid medium are of a size ranging from micrometers to millimeters in each dimension.

8. A device as in claim 1 and 2, wherein the particles of said solid medium are of a shape selected from the group comprised of spherical shapes, cubical shapes, cylindrical shapes, oval shapes, irregular shapes, porous membrane and combinations thereof.

10. A device as in claim 1, wherein said tube comprises a tube of multi-tube array.

11. A device as in claim 10, wherein multi tube array can be in 96, 384, 1536 well micro titer plate format.

12. A device as in claim 1 wherein said tube is a pipette tip.

13. A device as in claim 2, wherein said film is a plate and said plate or film can be porous or nonporous.

14. A method for the transport of small amount of chemicals or biochemicals by using the device as described in claim 1 and 2.

15. A device as in claim 1, wherein the tube can be of any length and diameter and can be composed of a combination of one or more different polymer materials from the group consisting of, but not limited to, polypropylene, polytetrafluoroethylene, polysulfone, polyethersulfone, cellulose acetate, polystyrene, polystyrene/acrylonitrile copolymer, PVDF and combination thereof.

16. A device as in claim 2, wherein the said film is composed of a combination of one or more different polymer materials from the group consisting of, but not limited to, polypropylene, PEEK, polytetrafluoroethylene, polysulfone, polyethersulfone, cellulose acetate, polystyrene, polystyrene/acrylonitrile copolymer, PVDF, metal, glass, porous and non porous material, woven or non-woven mesh, woven or non-woven net, and combination thereof.

17. A device as in claim 1, wherein said solid particles are in form of porous membrane or filter disk.

18. A method consisting of a tube or film containing solid polymer material such as chromatographic materials that adsorb on its surface a biomolecule such as enzymes for the biochemical reaction, the adsorption on the surface is non covalent and said biochemical reaction can take place on the surface of chromatographic media with said biomolecule adsorbed on said material, without said biomolecule being detached (deadsorbed) from said chromatographic material.
